(19) United States
(12) Patent Application Publication
(10) Pub. No.: US 2009/0183843 A1
(43) Pub. Date: Jul. 23, 2009

(54) VENETIAN BLIND HAVING CURVED-SECTIONED SLATS WITH TWO HORIZONTAL WING PORTIONS

(76) Inventor: Tser-Wen Chou, Yorba Linda, CA (US)

Correspondence Address: SCHMEISER, OLSEN & WATTS, 22 CENTURY HILL DRIVE, SUITE 302, LATHAM, NY, 12110, US

(21) Appl. No.: 12/017,383

(22) Filed: Jan. 22, 2008

(51) Int. Cl. E06B 9/24

(52) U.S. Cl. 160/218; 160/236

(57) ABSTRACT

A Venetian blind includes a plurality of horizontal slats which are positioned at a predetermined distance vertically and a lifting and rotating control unit. Each of the slats includes a transversely extended central portion having a curved cross section, and two wing portions horizontally extended from and along two opposite transverse edges of the curved central portion. The lifting and rotating control unit includes a lift cord vertically extended through openings provided on the slats, two ladder cords vertically located at two transverse sides of the slats, and a plurality of cross rung cords separately located below the slats and connected at two ends to the two ladder cords, such that the cross rung cords each have two end portions in contact with lower sides of the two wing portions. With the above arrangements, the slats may be smoothly rotated in an effort-saving manner to overlap one another to provide effective light blocking function.

### FIELD OF THE INVENTION

The present invention relates to a Venetian blind, and more particularly to a Venetian blind having specially designed slats for the cross rung cords to be better stretched, so that the slats may be smoothly rotated to overlap one another to effectively block light.

### BACKGROUND OF THE INVENTION

FIGS. 1 and 2 show a first conventional Venetian blind 3, which includes a plurality of horizontal slats 31, a lift cord 31, two ladder cords 33, and a plurality of cross rung cords 34. The slats 31 have an upward convex cross section each and are provided at predetermined positions with a through opening 311 each. The lift cord 32 is vertically extended through the openings 311 on the slats 31. The ladder cords 33 are separately located at two opposite transverse edges of the slats 31. The cross rung cords 34 are separately located below the slats 31 and connected at two ends to the two ladder cords 33. In this manner, two ends of the cross rung cords 34 are in point contact with the two opposite transverse edges of the slats 31. With the lift cord 32, the slats 31 may be lifted or lowered; and, with the ladder cords 33 and the cross rung cords 34, the slats 31 may be rotated by a desired angle, as shown in FIG. 3.

In the above-described conventional Venetian blind 3, since the slats 31 are in point contact at two transverse edges with two ends of the cross rung cords 34, the slats 31 do not apply a proper pressure to the cross rung cords 34, and the cross rung cords 34 can not be well stretched, accordingly. As a result, a user has to operate the Venetian blind 3 with more efforts, and the slats 31 might not be completely rotated to a vertical position to effectively block light. Moreover, since the openings 311 are located at a central position of the slats 31, the lift cord 32 tends to interfere with the through openings 311 when the slats 31 are rotated, preventing the lower edge of an upper rotated slat 31 from closing to the upper edge of a lower rotated slat 31. That is, light may still penetrate into an indoor space through a gap between the upper and the lower rotated slats 31 when viewing from a front side A of the Venetian blind 3, as shown in FIG. 3. Therefore, the conventional Venetian blind 3 provides only poor light-blocking function and the concave surfaces at a reverse side B of the slats 31 as shown in FIG. 3 is visually unpleasant.

FIGS. 4 and 5 show another conventional Venetian blind 4, which includes a plurality of horizontal flat slats 41, a lift cord 42 vertically extended through openings 411 separately provided on the flat slats 41 at predetermined positions, two ladder cords 43 located at two opposite transverse edges of the slats 41, and a plurality of cross rung cords 44 separately located below the slats 41 and connected at two ends to the two ladder cords 43.

The flat slats 41 of the Venetian blind 4 are in line contact at a lower surface with the cross rung cords 44. The contact area between the flat slats 41 and the cross rung cords 44 is larger than that between the curved slats 31 and the cross rung cords 34. However, it requires higher accuracy to produce the flat slats 41 with good planeness. In the event the flat slats 41 have poor planeness and unevenly distributed weight, it is still impossible for the slats 41 to uniformly press against the cross rung cords 44 to make it fully stretched and tensioned. In this case, the user also has to operate the Venetian blind 4 with extra efforts, and the slats 41 might not be completely rotated to a vertical position to provide good light-blocking effect. Moreover, since the flat slats 41 have a rectangular cross section each, and the lift cord 42 would interfere with the through openings 411 on the rotated slats 41, the lift cord 42 is induced to bias by a distance X, as shown in FIG. 6. Further, since the lower edge of an upper rotated slat 41 does not fully close on the upper edge of a lower rotated slat 41, a gap is existed between any two adjacent rotated slats 41 to allow external light to penetrate therethrough and into an indoor space. Therefore, the conventional Venetian blind 4 also provides only poor light-blocking function.

### SUMMARY OF THE INVENTION

A primary object of the present invention is to provide a Venetian blind having particularly designed slats for cross rung cords thereof to be better stretched, so that the slats may be smoothly rotated to overlap one another to effectively block light.

To achieve the above and other objects, the Venetian blind according to a preferred embodiment of the present invention includes a plurality of horizontal slats and a lifting and rotating control unit. The slats are positioned at a predetermined distance vertically; and each of the slats includes a transversely extended central portion having a curved cross section, and two wing portions separately horizontally outward extended from and along two opposite transverse edges of the curved central portion. The curved central portions of the slats are provided at predetermined positions with a through opening each. The lifting and rotating control unit includes a lift cord vertically extended through the openings on the slats, two ladder cords separately vertically located at two transverse edges of the slats, and a plurality of cross rung cords separately located below the slats and connected at two ends to the two ladder cords, such that the cross rung cords each have two end portions in contact with lower sides of the two wing portions.

With the above arrangements, the slats may be smoothly rotated in an effort-saving manner to overlap one another to provide effective light blocking function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary perspective view of a first conventional Venetian blind;

FIG. 2 is a sectional side view of FIG. 1;

FIG. 3 is another sectional side view of the Venetian blind of FIG. 1 with the slats thereof in a rotated state;

FIG. 4 is a fragmentary perspective view of a second conventional Venetian blind;

FIG. 5 is a sectional side view of FIG. 4;

FIG. 6 is another sectional side view of the Venetian blind of FIG. 4 with the slats thereof in a rotated state;

FIG. 7 is a fragmentary perspective view of a Venetian blind according to a preferred embodiment of the present invention;

FIG. 8 is a sectional side view of FIG. 7; and

FIG. 9 is another sectional side view of the Venetian blind of FIG. 7 with the slats thereof in a rotated state.

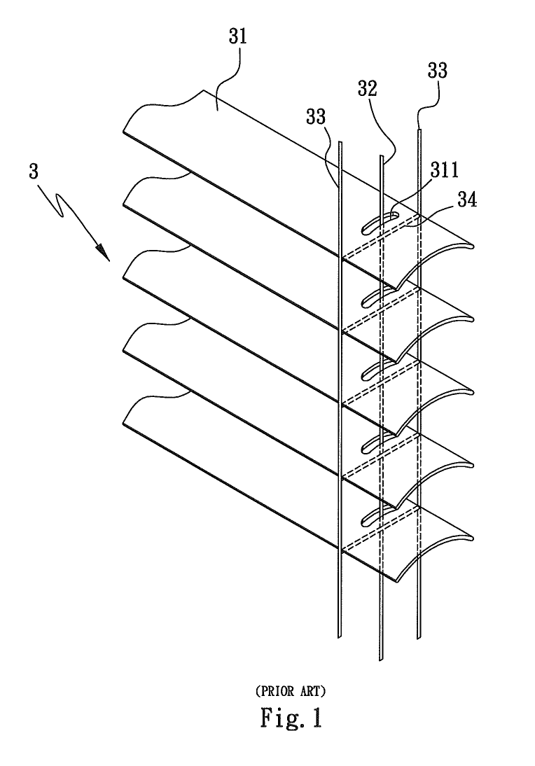

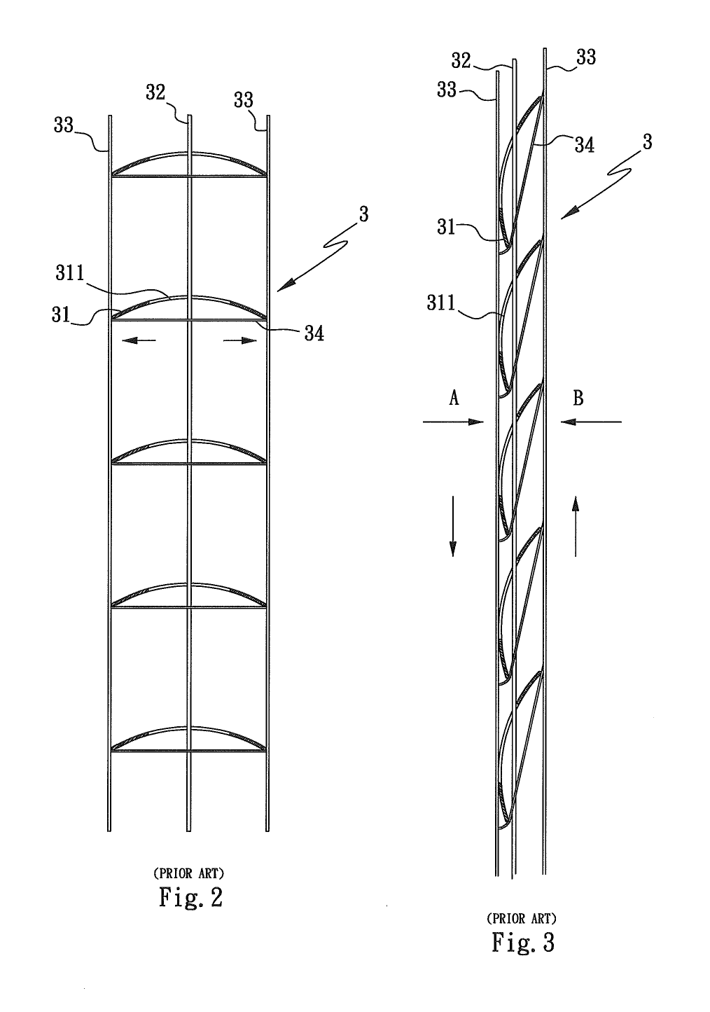

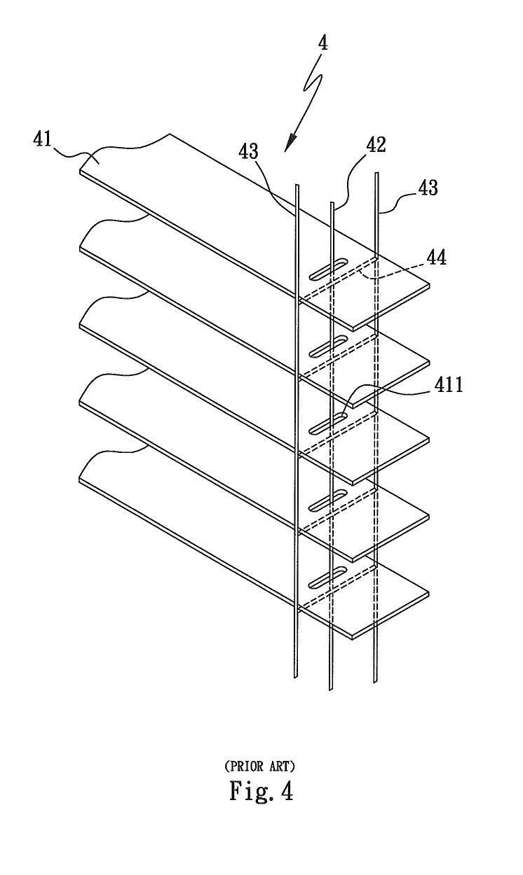

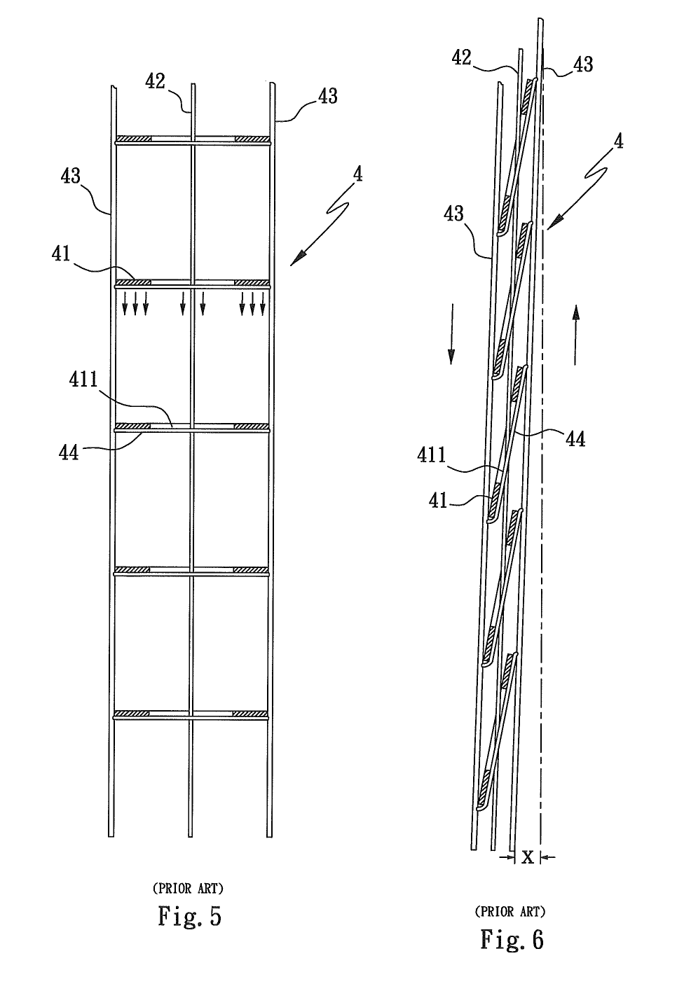

### DETAILED DESCRIPTION OF THE PREFERRED EMBODIMENTS

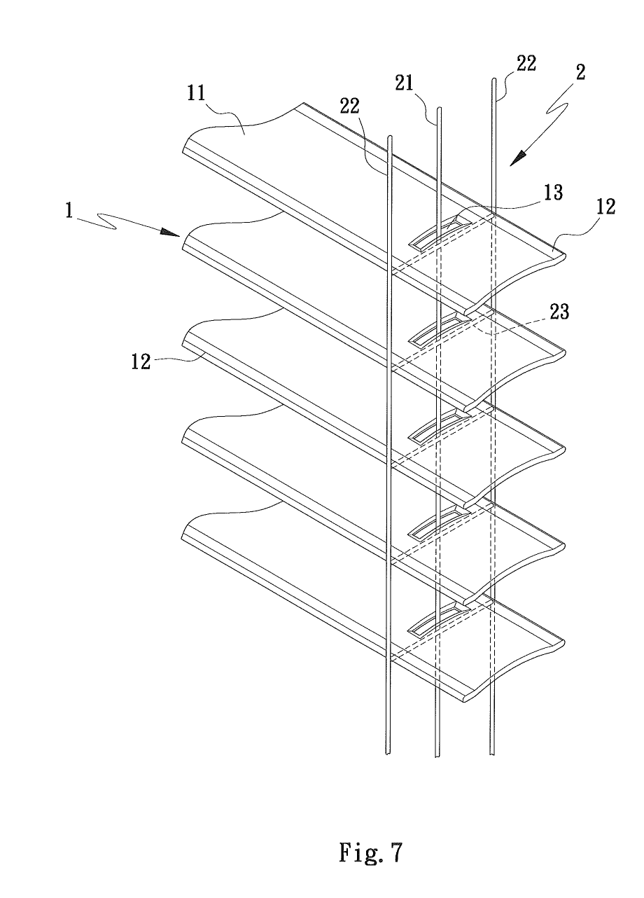

Please refer to FIG. 7 that is a fragmentary perspective view of a Venetian blind according to a preferred embodiment of the present invention. As shown, the Venetian blind of the present invention includes a plurality of horizontal slats 1 and a lifting and rotating control unit 2.

The slats 1 are positioned at a predetermined distance vertically. Each of the slats 1 includes a transversely extended central portion 11 having a curved cross section and two wing portions 12 separately outward extended from and along two opposite transverse edges of the curved central portion 11 by a predetermined distance. The slats 1 are so positioned that the curved central portion 11 are similarly oriented. The two wing portions 12 of each slat 1 are located in the same horizontal plane. Each of the slats 1 is provided on the curved central portion 11 at predetermined positions with a through opening 13 each.

The lifting and rotating control unit 2 includes a lift cord 21 which is vertically extended through the openings 13 on the slats 1, two ladder cords 22 separately vertically located at two transverse edges of the slats 1, and a plurality of cross rung cords 23 separately located below the slats 1 and connected at two ends to the two ladder cords 22. The cross rung cords 23 each have two end portions in contact with lower sides of the two wing portions 12.

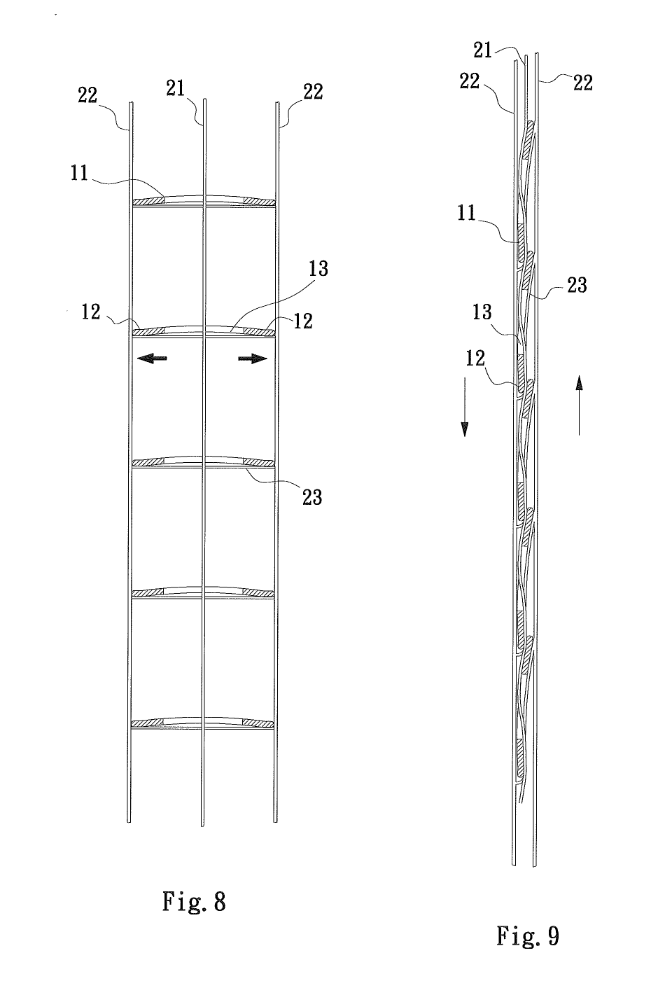

Please refer to FIGS. 8 and 9 that are sectional side views of the Venetian blind of the present invention showing the slats 1 thereof in a horizontal and a rotated state, respectively. As shown, in practical operation of the Venetian blind of the present invention, the lifting and rotating control unit 2 is coupled with lifting and rotating mechanisms to enable operations thereof. Since the lifting and rotating mechanisms are known techniques, they are not discussed in details, and only the effects that could be achieved through the present invention are described herein. To use the Venetian blind of the present invention, the slats 1 may be lifted or lowered via the lift cord 21 in cooperation with the cross rung cords 23, and the slats 1 may also be rotated by an angle to block light via the ladder cords 22 in cooperation with the cross rung cords 23.

In the present invention, with the two wing portions 12 located in the same horizontal plane at two opposite transverse edges of the curved central portion 11 of each slat 1, a proper and uniform gravity force is produced by the wing portions 12 to press against the cross rung cord 23, so that the cross rung cord 23 subjected to the pressure from the wing portions 12 may be better stretched. Further, with the lift cord 21 and the ladder cords 22, the cross rung cords 23 may be relatively tightly tensioned, so that the slats 1 located above the cross rung cords 23 may be smoothly lifted or lowered or rotated in a labor-saving manner without the risk of incomplete lifting, lowering, or rotating.

Moreover, when the slats 1 are rotated to block light, the design of the curved central portion 11 and the two wing portions 12 prevents the lift cord 21 extended through the openings 13 from biasing from a vertical direction. Meanwhile, when the slats 1 are rotated, the lower wing portion 12 of an upper slat 1 overlaps the upper wing portion 12 of a lower slat 1 to enable the rotated slats 1 to provide an improved light blocking effect. Moreover, the curved central portions 11 make the rotated slats 1 visually more beautiful at either side.

With the above arrangements, the Venetian blind of the present invention effectively overcomes the drawbacks in the conventional Venetian blinds, so that the slats 1 with the curved central portions 11 and the two wing portions 12 allow the cross rung cords 23 to rotate the slats 1 smoothly in order to provide effective light-blocking function.

What is claimed is:

1. A Venetian blind, comprising a plurality of horizontal slats, each of the slats including a transversely extended central portion having a curved cross section, and two wing portions separately outward extended from and along two opposite transverse edges of the curved central portion; and the curved central portions being provided at predetermined positions with a through opening each.

2. The Venetian blind as claimed in claim 1, wherein the slats are positioned with the curved central portions oriented toward the same direction.

3. The Venetian blind as claimed in claim 1, wherein the wing portions extended from the two opposite transverse edges of the curved central portion are located in the same horizontal plane.

4. A Venetian blind, comprising:
a plurality of horizontal slats being positioned at a predetermined distance vertically; and each of the slats including a transversely extended central portion having a curved cross section, and two wing portions separately outward extended from and along two opposite transverse edges of the curved central portion; and the curved central portions being provided at predetermined positions with a through opening each; and
a lifting and rotating control unit including a lift cord vertically extended through the openings on the slats, two ladder cords separately vertically located at two transverse sides of the slats, and a plurality of cross rung cords separately located below the slats and connected at two ends to the two ladder cords; and
the cross rung cords each having two end portions in contact with lower sides of the two wing portions.

5. The Venetian blind as claimed in claim 4, wherein the slats are positioned with the curved central portions oriented toward the same direction.

6. The Venetian blind as claimed in claim 4, wherein the wing portions extended from the two opposite transverse edges of the curved central portion are located in the same horizontal plane.
